(19) United States
(12) Patent Application Publication
(10) Pub. No.: US 2021/0185608 A1
(43) Pub. Date: Jun. 17, 2021

(54) COOPERATIVE ENERGY EFFICIENT TRACKING SYSTEM AND METHOD USING ELECTRONIC DEVICES

(71) Applicant: King Fahd University of Petroleum and Minerals, Dhahran (SA)

(72) Inventors: Yousef Ali, Dhahran (SA); Uthman Baroudi, Dhahran (SA)

(73) Assignee: King Fahd University of Petroleum and Minerals, Dhahran (SA)

(21) Appl. No.: 16/713,931

(22) Filed: Dec. 13, 2019

(51) Int. Cl. H04W 52/02; H04W 4/38

(52) U.S. Cl. CPC H04W 52/0219; H04W 84/18; H04W 4/38

(57) ABSTRACT

A system, an apparatus, and a method for tracking an object using electronic devices are provided. The system includes a plurality of electronic devices and a server. Each electronic device includes a short-range transmitter, a long-range transmitter, and processing circuitry. The electronic device broadcasts data, identifies as a regular node or a cluster head based on at least the clustering cost, transmits location data to the cluster head when the electronic device is identified as the regular node, and transmits gathered location data to a server when the electronic device is the cluster head. The server identifies the cluster of electronic devices, identifies the cluster head for the cluster, determines a position of the cluster head using data received via the long-range transmitter of the cluster head, determines a position of each electronic device within the cluster, and stores the position of each electronic device in the server.

### STATEMENT OF PRIOR DISCLOSURE BY AN INVENTOR

One or more aspects of the present disclosure were described in Ali, Yousef & Baroudi, Uthman. (2019). CEET: Cooperative Energy Efficient Tracking System using Smartphones. 1031-1036. 10.1109/IWCMC.2019.8766513, incorporated herein by reference in its entirety.

### BACKGROUND

### Field of the Invention

This invention generally relates to a method and corresponding system for tracking. In particular, the invention provides a method and corresponding system for tracking an object using electronic devices while minimizing power consumption of the electronic devices.

### Background of the Invention

Mobile applications and services have become important in every aspect of life due to the extraordinary technological advances and high popularity of smartphones. Internet communication and positioning services are among the essential services in recent smartphones. Global positioning system (GPS) and WiFi are the most prevalent technologies used for positioning and internet communication, respectively. See Misra, P., Enge, P. (2006), Global Positioning System: signals, measurements and performance second edition, Massachusetts: Ganga-Jamuna Press; and IEEE Computer Society LAN MAN Standards Committee, (1999), Wireless LAN medium access control (MAC) and physical layer (PHY) specifications, ANSI/IEEE Std. 802.11-1999, each incorporated herein by reference in their entirety. Almost every recent smartphone is equipped with a WiFi and a positioning system. GPS and WiFi are preferable among other alternatives, GPS due to its high positioning accuracy compared to other positioning systems, and WiFi due to its high bandwidth, flexibility, well-designed and widespread infrastructure. However, GPS and WiFi are known for their high energy consumption. Continuous usage of WiFi and GPS would deplete a smartphone battery within a few hours even if there no other services are running on the device. On the other hand, energy efficiency of smartphones is commonly considered as a major concern since smartphones have restricted battery capacity due to the size and weight of the phone.

Using smartphones for monitoring large scale events provides an excellent opportunity for seamless and effective tracking. The need of real time tracking of people with special needs, such as children, the elderly and chronic patients, can be satisfied by smartphones. In such crowds and dense networks, there are more energy efficient solutions that can reduce power consumption and still maintain acceptable quality of service (QoS). For example, using short range communication in dense networks is more energy efficient. The use of a low-power communication interface as a secondary communication means has been used to save energy. See Ligios, M., Delgado, M. T., Conzon, D., Rossini, R., Sottile, F., Pastrone, C. (2018, January) Cognitive-based multi-radio prototype for industrial environment, Annals of Telecommunications, 1-12; Agarwal, Y., Pering, T., Want, R., Gupta, R. (2008, September), Switchr: Reducing system power consumption in a multi-client, multi-radio environment, In Wearable Computers, 2008, ISWC 2008, 12th IEEE International Symposium on (pp. 99-102), IEEE; Pering, T., Agarwal, Y., Gupta, R., Want, R. (2006, June), Coolspots: reducing the power consumption of wireless mobile devices with multiple radio interfaces, In Proceedings of the 4th international conference on Mobile systems, applications and services (pp. 220-232), ACM; and Agarwal, Y., Schurgers, C., Gupta, R. (2005, January), Dynamic power management using on demand paging for networked embedded systems, In Proceedings of the 2005 Asia and South Pacific Design Automation Conference (pp. 755-759), ACM, each incorporated herein by reference in their entirety. Bluetooth is an example of a low-power short-range communication technology that is available in almost every smartphone in the market. Bluetooth popularity is due to its high security, low power, low cost and small size chip. See Lee, J. S., Su, Y. W., Shen, C. C. (2007, November), A comparative study of wireless protocols: Bluetooth, UWB, ZigBee, and WiFi, In Industrial Electronics Society, 2007, IECON 2007, 33rd Annual Conference of the IEEE (pp. 46-51), incorporated herein by reference in its entirety.

Clustering of wireless devices has been widely investigated by the research community with different objectives. Energy efficiency is essential for wireless sensors due to their limited batteries. LEACH is one of the earliest and well known algorithms for saving energy for wireless sensor networks. See W. B. Heinzelman, A. P. Chandrakasan, and H. Balakrishnan, An application-specific protocol architecture for wireless microsensor networks, IEEE Transactions on wireless communications, vol. 1, no. 4, pp. 660670, 2002, incorporated herein by reference in its entirety. In LEACH cluster heads gather data from regular nodes, aggregates the data then sends the data to the sink. To balance the load among cluster nodes, the cluster head role is rotated periodically based on a priority values randomly generated and assigned to each member in the cluster. However, the randomization to rotate the cluster head cannot assure fairness in load balancing among cluster nodes especially with mobile networks which were not considered in the protocol design. Another variation of LEACH was introduced in Zhixiang et al. called TL-LEACH. See D. Zhixiang and Q. Bensheng, Three-layered routing protocol for wsn based on leach algorithm, 2007, incorporated herein by reference in its entirety. The method describes a hierarchical approach with three layers. First layer consists of the regular nodes while a second layer for cluster heads that aggregate data from regular nodes. Nodes with higher battery levels are selected for the third layer. Nodes in the third layer act as relays between the cluster head and the sink. This algorithm outperforms the original LEACH in terms of the energy saving. An enhancement to TL-LEACH algorithm includes a centralized optimization model for selecting the third layer nodes. The fuzzy c-means algorithm is used to minimize the overall distance between nodes and their cluster head and subsequently increase the communication energy efficiency. Another enhancement to LEACH supports multi-hop clustering and reduces the power consumption by including new rules for CH selection and rotation. A multi-hop model is used based on leveling and generic routing. Most of the known aforementioned methods do not consider node mobility after clustering.

Clustering of mobile nodes has posed new challenges in terms of connectivity and energy efficiency. A number of clustering protocols have been proposed to support node mobility. One of the earliest protocols that support node mobility is LEACH-M protocol which is a modified version of LEACH. The protocol includes using a membership declaration to confirm the enrolment of sensor nodes in a specific cluster. If a sensor node did not receive a request from its cluster head during two consecutive frames, it assumes that it has moved out of the cluster head communication range. Then, the node broadcasts a request to join a new cluster. LEACHM protocol increases the packet delivery rate but it also increases the control massages overhead. Another approach includes selecting a cluster head a node with less mobility relative to its neighbors. The node with minimum mobility in a group is more likely to be chosen as a cluster head. A cluster based routing CBR-Mobile protocol for mobile sensor nodes has been proposed in Awwad et al. See S. A. Awwad, C. K. Ng, N. K. Noordin, and M. F. A. Rasid, Cluster based routing protocol for mobile nodes in wireless sensor network, Wireless Personal Communications, vol. 61, no. 2, pp. 251281, 2011, incorporated herein by reference in its entirety. The CBR-Mobile is an adaptive TDMA scheduling protocol that can reassign time slot adaptively according to the mobility and traffic conditions in the network. CBR-Mobile is a cross layer protocol where the cluster based routing cooperates with the MAC layer to support the node mobility. CBR-Mobile can improve the packet delivery ratio but with the cost of increasing the control messages overhead. Another approach, HEED uses a vector of metrics for choosing CH such as residual energy and within cluster communication cost. See O. Younis and S. Fahmy, Heed: a hybrid, energy-efficient, distributed clustering approach for ad hoc sensor networks, IEEE Transactions on mobile computing, vol. 3, no. 4, pp. 366379, 2004, incorporated herein by reference in its entirety. The cluster head role is not randomly rotated like LEACH but according to battery level of each node which assures a longer lifetime for the network. However, HEED considers prolonging the network lifetime and overlooks the fairness among nodes which make it more suitable for scenarios of group networking where the whole network nodes share the same task. CONET is an energy efficient distributed clustering protocol for mobile devices with multiple communication interfaces. Inter clusters communication is performed via Bluetooth and cluster heads represent gateways between the cluster members and the WiFi access point. Only CH enables its WiFi which saves energy for rest of the cluster members. Selection of the cluster head depends on the bandwidth requirements and the energy saving ratio. To force fairness and load balancing every regular node set a timer when joining a cluster. RN disconnect from the cluster when the timer expires. An extension to CONET has been introduced in Mishra et al. proposing three cost metrics for clustering: the residual energy, WiFi physical data rate and number of mobile stations expected to cooperate. See N. Mishra, K. Chebrolu, B. Raman, and A. Pathak, Wake-on-wlan, in Proceedings of the 15th international conference on World Wide Web, A C M, 2006, pp. 761769, incorporated herein by reference in its entirety.

However, it has always been a challenging task to increase the energy saving in a system that includes mobile devices. Accordingly, what is needed, as recognized by the present inventor, is a method for tracking an object that minimizes the usage of long-range transmitters.

The foregoing “Background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention.

### SUMMARY

The present disclosure relates to a system for tracking an object using electronic devices are provided. The system includes a plurality of electronic devices and a server. Each electronic device includes a short-range transmitter, a long-range transmitter, and processing circuitry. The processing circuitry of the electronic device is configured to broadcast data via the short-range transmitter, the data including a clustering cost, identify as a regular node or a cluster head for a cluster based on at least the clustering cost associated with each of the electronic devices, transmit location data to the cluster head using the short-range transmitter when the electronic device is identified as the regular node, and transmit gathered location data to a server using the long-range transmitter when the electronic device is the cluster head, the gathered location data including the location data received from other electronic devices in the cluster. The server is configured to identify the cluster of electronic devices, identify the cluster head for the cluster, determine a position of the cluster head using data received via the long-range transmitter of the cluster head, determine a position of each electronic device within the cluster using the gathered location data and the position of the cluster head, and store the position of each electronic device in a database of the server.

The present disclosure also relates to an electronic device. The electronic device includes a short-range transmitter, a long-range transmitter, and processing circuitry. The electronic device is configured to broadcast data via the short-range transmitter, the data including a clustering cost, determine whether a join request is received from another electronic device to form a cluster, accept the join request when a bandwidth associated with the electronic device is greater than a predetermined threshold, receive location data from the another electronic device, transmit the location data to a server using the long-range transmitter. The present disclosure also relates to a method for tracking an object using electronic devices. The method includes broadcasting data via a short-range transmitter of an electronic device, the data including a clustering cost; determining whether a join request is received from another electronic device to form a cluster; accepting the join request when a bandwidth associated with the electronic device is greater than a predetermined threshold; receiving location data from the another electronic device; and transmitting the location data to a server using a long-range transmitter of the electronic device.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram that shows a system for tracking an object according to one example;

FIG. 2 is a schematic that illustrates cluster head (CH) advertisement according to one example;

FIG. 3 is a schematic that shows an example of a node selecting a cluster head from two neighboring CHs;

FIG. 4 is a schematic that illustrates cluster head timer expiration according to one example;

FIG. 5 is a flowchart for a method for tracking an object according to one example;

FIG. 6 is a schematic that illustrates a comparison of initial clustering construction in term of power consumption according to one example;

FIG. 7 is a schematic that illustrates a comparison of power consumption for the whole network in respect to the value of the objective function generated according to one example;

FIG. 8 is a schematic that illustrates a comparison of cluster size with random data rate between 0 and 1 mbps according to one example;

FIG. 9 is a schematic that illustrates a comparison of cluster size for a predetermined data rate according to one example;

FIG. 10 is a schematic that illustrates an effect of node density on the cluster organization according to one example;

FIG. 11 is a schematic that shows the power consumption of the system according to one example;

FIG. 12 is a schematic that shows the power consumption of the system using 3g mobile data with different node density according to one example;

FIG. 13 is a schematic that shows the power consumption of the system for different node density according to one example;

FIG. 14 is a schematic that shows the power consumption in a modified approach of the system according to one example;

FIG. 15 is a schematic that shows a comparison of cumulative battery capacity for the system according to one example;

FIG. 16 is a schematic that shows the number of dead nodes out according to one example;

FIG. 17 is a schematic that shows the fairness of energy saving according to one example;

FIG. 18 is a schematic that shows the Jain fairness Index in the random CH selection according to one example;

FIG. 19 is a schematic that shows the effect of switching period on fairness and stability of the network according to one example; and

FIG. 20 is a block diagram of a server according to one example.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Referring now to the drawings, wherein like reference numerals designate identical or corresponding parts throughout several views, the following description relates to a cooperative energy efficient tracking (CEET) system and associated methodology based on electronic devices (e.g., smartphones) clustering where neighboring electronic devices form a cluster and cooperatively perform the tracking task. Cluster members share the task of positioning. A single electronic device performs positioning to determine positioning information and then shares the positioning information with the rest of its cluster members, instead of making each electronic device do the positioning operations individually.

In one implementation, the electronic devices include smartphones equipped with class 2 Bluetooth device transmitters which can communicate effectively within 10 meters range. This assures a positioning accuracy with error up to 10 meters in addition to the positioning error resulting from global positioning system (GPS). This range of error is acceptable for many tracking applications. In addition to the energy saved from positioning, a significant amount of energy can be saved from communication. Cluster members reside within small areas, so communication within clusters can be done using short range radio interfaces that consumes low power such as Bluetooth. Communication within a cluster is done via Bluetooth. So a cluster is considered as a Bluetooth Personal Area Network. A Cluster is composed of one cluster head (CH) and regular members. CH acts as a gateway between the cluster regular nodes (RNs) and the WiFi access point via Bluetooth. The low-power transmitter such as Bluetooth is used for all cluster configuration messages such as broadcasting and cluster construction. CHs are also carrying out the positioning process as described further below.

The CEET methodology described herein doesn't require any modifications in the manufacturing equipment. Each user may download an application to be installed on the electronic device associated with the user. The application, from the user point of view, is responsible of positioning and reporting the tracking information to a server. In addition to the mobile application, a server side application is responsible of processing the tracking information received from users as described further below.

The clustering problem is modeled as a mix integer programming (MIP) problem and solved using a general algebraic modeling system (GAMS) to obtain the optimal cluster construction that minimizes energy consumption as described further below. See GAMS Development Corporation, General Algebraic Modeling System, Release 24.2.1, Washington, DC, USA, 2013, incorporated herein by reference in its entirety.

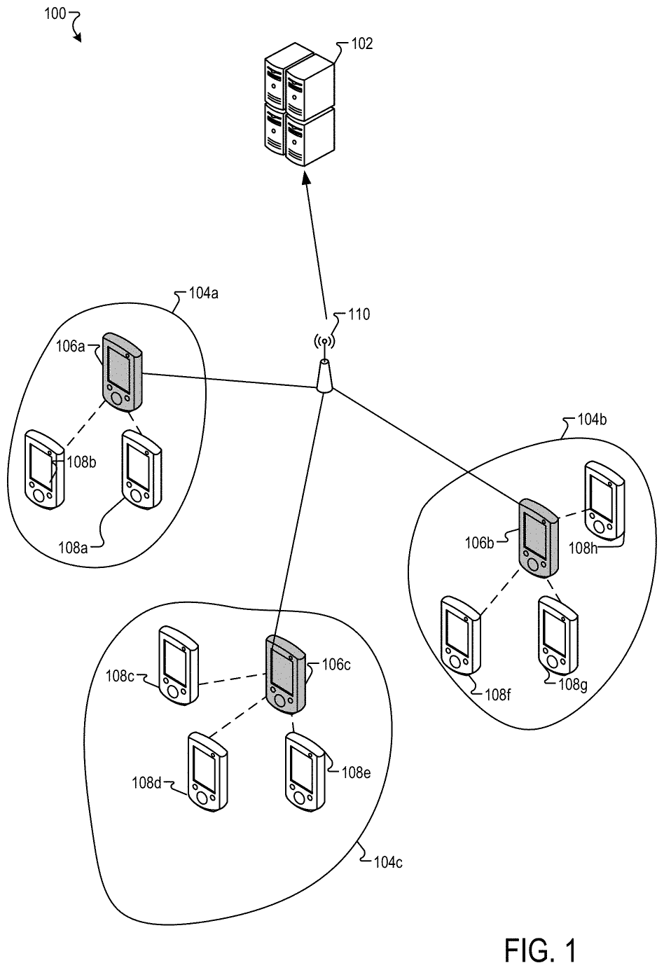

FIG. 1 is a block diagram that shows a system 100 for tracking an object according to one example. The system 100 includes a plurality of electronic devices 108, a base station 110, and a server 102. The electronic devices 108 are also referred to as nodes herein. The electronic devices 108 are grouped into clusters 104 using the method described herein. For example, a first cluster 104a includes electronic devices 108a, 108b, and a cluster head 106a. A second cluster 104b includes electronic devices 108f, 108g, 108h, and a cluster head 106b. A third cluster 104c includes electronic devices 108c, 108d, 108e, and a cluster head 106c.

The number of electronic devices 108, the number of clusters 104, and the number of electronic devices within a cluster 104 as shown in FIG. 1 are for ease of illustration and explanation.

The electronic device 108 includes a smartphone, a tablet, a laptop, a smart watch, and the like. The electronic device 108 includes a processor or a controller. The processor may be implemented using any type of electronic or other circuitry which is configured to perform the method described herein such as the cluster head selection. The controller may include integrated circuitry such as controllers, microprocessors, digital signal processors, application specific integrated circuits, field programmable gate array, and any associated memory. Further, the electronic device 108 includes an energy source (e.g., battery). The energy source may be replaceable or rechargeable.

The electronic device 108 is equipped with at least two communications modules. A first communication module consumes low power and has a short communication range. A second communication module consumes high power and has a long communication range. For example, the electronic device 108 includes a short-range transmitter and a long-range transmitter.

In one implementation, the electronic devices are equipped with Bluetooth, WLAN/mobile data and GPS. Each node has an access to the Internet either through a WLAN access point or through cellular networks. Participants associated with the electronic devices 108 often move, the clustering method described herein provide seamless hand off from one cluster to another. In one implementation, all electronic devices have the same Bluetooth range.

The base station 110 is one or more base stations. The base station 110 communicates with the cluster heads 106 (e.g., 106a, 106b, 106c) using the second communication method (i.e., the long range transmitter). Further, the base station 110 communicates with the server 102.

The server 102 represents one or more servers 102 that receive the location of the one or more electronic devices 108 via the base station 110.

Algorithm 1 is a pseudo code that represents the clustering operations described herein.

Algorithm 1: The clustering algorithm

| | Data: | S_{ch} is set of neighboring CHs | | | |
|---|---|---|---|---|---|
| | | S_{bch} is set of bruned CHs | | | |
| | | CHₜᵢₘₑ is the time a node should serve as a CH | | | |
| | | when selected | | | |
| 1 | while battery is not drained do | | | | |
| 2 | \| | Become a CH; | | | |
| 3 | \| | broadcast data; | | | |
| 4 | \| | if join request received then | | | |
| 5 | \| | \| | if have enough bandwidth then | | |
| 6 | \| | \| | \| | if RNs in the cluster = 0 then | |
| 7 | \| | \| | \| | \| | Set CH timer=CHₜᵢₘₑ; |
| 8 | \| | \| | \| | end | |
| 9 | \| | \| | \| | send accept; | |
| 10 | \| | \| | else | | |
| 11 | \| | \| | \| | send reject; | |
| 12 | \| | \| | end | | |
| 13 | \| | end | | | |
| 14 | \| | if | RNs exist in the cluster then | | |
| 15 | \| | \| | Set CH timer = 0 Continue | | |
| 16 | \| | else | | | |
| 17 | \| | \| | forall CHs in S_{ch} do | | |
| 18 | \| | \| | \| | CH_{best} = CH with highest CH timer in S_{ch} | |
| | \| | \| | \| | then the lowest cost if timers are equal; | |
| 19 | \| | \| | \| | send a join request to CH_{best} ; | |
| 20 | \| | \| | \| | if receive an accept then | |
| 21 | \| | \| | \| | \| | become a RN ; |
| 22 | \| | \| | \| | \| | set RN timer ; |
| 23 | \| | \| | \| | \| | while CH timer is not expired CHi is |
| | \| | \| | \| | \| | reachable bandwidth is satisfied do |
| 24 | \| | \| | \| | \| | \| continue as RN |
| 25 | \| | \| | \| | \| | end |
| 26 | \| | \| | \| | else | |
| 27 | \| | \| | \| | \| | move CH_{best} to S_{bch} |

| | | | | |
|---|---|---|---|---|
| 28 | \| | \| | \| | end |

| | | | |
|---|---|---|---|
| 29 | \| | \| | end |

| | | |
|---|---|---|
| 30 | \| | end |

| | |
|---|---|
| 31 | end |

Cluster head advertisement: When a node is booted up, the node announces itself as a cluster head and the node broadcasts information about itself like the available bandwidth, current cost, location information, ID and network address. Initially, the reciprocal value of the electronic device battery level is considered as the clustering cost value. Since the node is just booted up, the node is not connected to regular nodes. The node corresponds to a trivial cluster head. The node waits for receiving join requests and checking for neighboring CHs, simultaneously.

Non-trivial cluster heads (cluster heads that have connected regular nodes within the cluster) announce the CH timer instead of clustering cost. CHs with higher timers are more likely to be selected by other nodes because the nodes then spend more time as regular nodes, thus, save more energy. CH stops advertising when a maximum allowed number of RNs connected to the CH is reached.

Nodes advertise their resources through the short-range transmitter (e.g., Bluetooth) and they keep broadcasting as long as they are cluster heads. Once a node is admitted as a regular node to a cluster, it stops advertising and starts to forward its tracking information through the short-range transmitter to the cluster head.

Cluster Head Selection: If a CH has no RNs in the cluster (trivial CH), neither receives a join request, it tries to find a neighboring CH to connect to. The processing circuitry of the electronic device acting as a CH selects the CH with highest CH timer provided that it has sufficient bandwidth. Choosing a CH with higher timer assures that the node can stay a longer time as a RN therefore reduce the number of hand offs and increase the energy efficiency. If there is no nearby CHs, the processing circuitry of the node selects next trivial CH with the lowest clustering cost. If the processing circuitry of a node selects a CH, the processing circuitry sends a join request via the short-range transmitter. If the node is accepted, the node becomes a regular node in the cluster. If the node receives a reject or does not receive an acceptance within a predetermined period (e.g., 3 minutes), the node tries to join the next CH following the same procedure. The node keeps its role as CH as long as it does not receive an acceptance message.

CH checks always number of RNs in its cluster. If there is at least one node, it keeps its role as a CH. If it receives a join request, it accepts the join request as long as it has sufficient bandwidth and the number of connected nodes is less than the maximum allowed number of slaves in piconet. If a trivial cluster head receives a join request and accepts it, it set a timer to define the time it will serve as a cluster head. It accepts join requests as long as it is in the cluster head role.

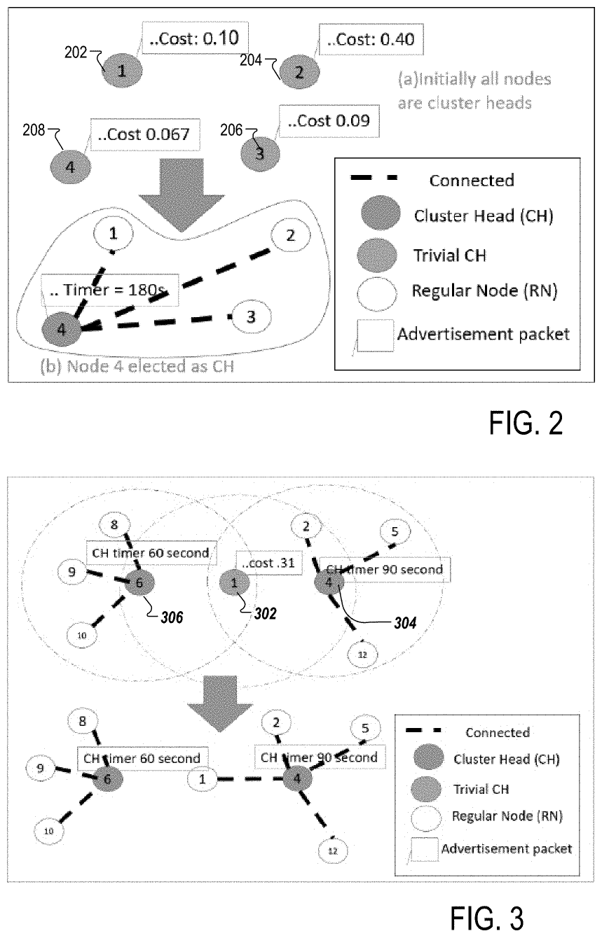

FIG. 2 is a schematic that illustrates an example of cluster head advertisement according to one example. A first node 202, a second node 204, a third node 206, and a fourth node 208 have booted up simultaneously. In the initial state, the first node 202, the second node 204, the third node 206, and the fourth node 208 are cluster head nodes. The first node 202, the second node 204, the third node 206, and the fourth node 208 advertise their resources along with their clustering cost at the same time (e.g., battery level). The first node 202, the second node 204, the third node 206, and the fourth node 208 listen to packets of other nodes while advertising their packets. Advertisement messages are transmitted through the short range communication method (e.g., Bluetooth) and all nodes are within the range of each other (e.g., Bluetooth range), so each node can listen to all advertising packets of all other nodes. Since the fourth node 208 has the lowest cost, the first node 202, the second node 204, the third node 206, send a join request to the fourth node 208. The fourth node 4 sends an acceptance acknowledgment for nodes assuming that it has a sufficient bandwidth to serve them all. Nodes other than the fourth node 208 (i.e., the first node 202, the second node 204, the third node 206) change their role to regular node and stop advertising. The fourth node 208 continues advertising but it advertises the CH timer associated with the fourth node 208 instead of the clustering cost.

FIG. 3 is a schematic that shows an example of a node selecting a cluster head from two neighboring CHs. A first node 302 hears the advertisements of a first cluster head 304 and a second cluster head 306. Since the first cluster head 304 has the lowest cost, the first node 302 selects to join the first cluster head 304. The first cluster head 304 accepts the join request if the cluster had has sufficient bandwidth as described later herein.

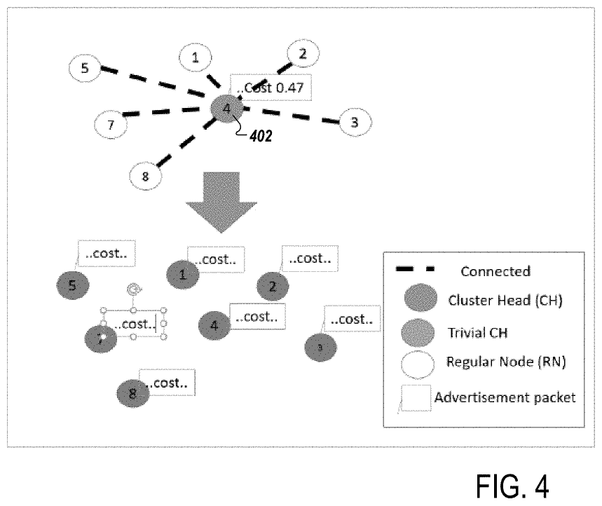

Role switching: To balance the energy saving among all nodes in the network, it is important to rotate the CH role routinely among all nodes. When a node (trivial cluster head) is selected as a cluster head, it starts a timer for a predefined period. When the timer expires, it disconnects from all connected regular nodes in its cluster as shown in FIG. 4. A cluster head 402 disconnect from all the nodes. All nodes after disconnecting from the cluster starts looking for the next cluster head. Either they connect to an existed cluster or elect one of them to be a cluster head. Unless a node is admitted to a new cluster, it changes its role to be a trivial CH.

Connection loss: Besides the RN timer expiration, there are other reasons to disconnect from a cluster such as connection loss. The cluster head may become unreachable due to its mobility or the mobility of the regular node itself. If a regular node becomes outside the range of the short range communication method of the cluster head, the regular node hands off and starts the procedure of finding next cluster head. The connection loss may also occur due to the failure of the cluster head itself such us switching off the short range communication method or switching off the electronic device.

Bandwidth Requirements: The data rate may be constant. The electronic devices collect small amount of data from health sensors and report it periodically (i.e., 30 seconds). This corresponds to small number of bytes per second which can be satisfied by the cluster head all the time. The data rate may be also a variable data rate. Thus, as the data rate is changing over time, the bandwidth requirements of all regular nodes is satisfied all the time by the cluster head. A regular node is disconnected from the cluster in response to determining that the cluster head cannot serve its bandwidth. The regular node may determine that the cluster head cannot serve its bandwidth based on information received from the cluster head. Additionally or alternatively the cluster head can determine whether the cluster head has enough bandwidth for the regular node.

Power Consumption Formulation: The system and method described herein minimizes the energy used by the electronic devices for tracking purpose. The energy saving is fair for all participating smartphones. The clustering algorithm described herein shares the task of localization and communication among nodes within every cluster. The goal of the clustering method is to find the optimal selection of the cluster head and normal members for each cluster, with goal of minimizing tracking energy. Thus, the tracking power is used as the cost function. The cost function is approximately equal for all participating smartphones as much as possible.

In one implementation, the electronic device is a smartphone that starts to cooperate at time 0, its role as a cluster head or a regular member can be determined depending on usage history of its resources. To compute the cost of node (i) at time (t), the energy consumption history of node (i) is considered. For that the cumulative amount of energy used by the node since its participation is used. The cost of node (i) at time (t) is the cumulative power from time 0 to time (t) divided by the expected power used to achieve the task in the traditional way (GPS and WiFi) for the same period. Therefore, the costᵢ(t) can be expressed as follows:

$${cost}_{i} ( t ) = \frac{{P}_{i}^{CEET}}{{P}_{i}^{trd}} \qquad ( 1 )$$

where Pᵢ^{CEET} represents the power consumption by node (i) when running CEET protocol and Pᵢ^{trd} represents the expected power that would be used by node (i) through the traditional way for positioning and communication. In the traditional approach, the power needed is the GPS power and WiFi power. Therefore, Pᵢ^{trd} can be defined as follows:
where Pᵢ^{w} represents WiFi power to transmit local data (rᵢ) of node (i) and Pᵢ^{G} represents GPS of node (i). Pᵢ^{w} is defined as follows:

$${P}_{i}^{W} = {P}_{i}^{{W}_{A}} \frac{{r}_{i}}{{R}_{i}^{w}} + {P}_{i}^{{W}_{I}} ( 1 - \frac{{r}_{i}}{{R}_{i}^{w}} ) \qquad ( 3 )$$

Similarly the Bluetooth power (Pᵢ^{B}) to transmit rᵢ may be calculated as follows:

$${P}_{i}^{B} = {P}_{i}^{{B}_{A}} \frac{{r}_{i}}{{R}_{i}^{B}} + {P}_{i}^{{B}_{I}} ( 1 - \frac{{r}_{i}}{{R}_{i}^{B}} ) \qquad ( 4 )$$

Pᵢ^{W}^{_{A}} and Pᵢ^{B}^{_{A}} represent WiFi and Bluetooth power of node i when they are active (i.e. transmitting). Rᵢ^{w} denotes the maximum transmission rate for the WiFi interface, while Pᵢ^{W}^{_{I}} and Pᵢ^{B}^{_{I}} represent both, respectively, when they are idle (listening but not sending or receiving).

The following equation represents the cumulative energy:

Eᵢ^{new}=Eᵢ^{old}+Pᵢ^{CEET} (5)

Pᵢ^{CEET} depends on the current role of the node whether it is a regular node or a cluster head. If node i current role is RN, then Pᵢ^{CEET} is equal to Pᵢ^{B} where Pᵢ^{B} denotes the Bluetooth power to forward node i local data to its cluster head. If node (i) is a cluster head, then current Pᵢ^{CEET} can be defined as follows:

$$\begin{matrix} {P}_{i}^{CEET} = {P}_{i}^{W} + {P}_{i}^{G} + {P}_{i}^{B} + {\sum }_{\begin{matrix}j = 1 \\ i \neq j\end{matrix}}^{n} {X}_{ij} \text{?} {P}_{j}^{Frwd} & ( 6 ) \\ {X}_{ij} = \{ \begin{matrix}1 & if node j is connected to CH i \\ 0 & otherwise\end{matrix} \\ \text{?} \text{indicates text missing or illegible when filed} & ( 7 )\end{matrix}$$

Pⱼ^{frwd} represents the power needed by CH i to forward data of node j which is a regular node in the same cluster. The following equation defines the Pⱼ^{frwd}:

$${P}_{j}^{frwd} = \frac{{r}_{j}}{{R}_{i}^{B}} ( {P}_{i}^{{B}_{A}} - {P}_{i}^{{B}_{I}} ) + \frac{{r}_{j}}{{R}_{i}^{W}} ( {P}_{i}^{{W}_{A}} - {P}_{i}^{{W}_{I}} ) \qquad ( 8 )$$

Rᵢ^{B} and Rᵢ^{w} represent the maximum transmission rate for Bluetooth and WiFi of node i. rⱼRᵢ_{_{A}}^{B} represents the power consumed by CH i to receive data from node j through Bluetooth. Since the power to receive the data of node j is added, then Bluetooth idle power is subtracted for the time to receive the same amount of data which is represented by rⱼ.Rᵢ_{_{I}}^{B}. Therefore, the expression

$$\frac{{r}_{j}}{{R}_{i}^{B}} ( {P}_{i}^{{B}_{A}} - {P}_{i}^{{B}_{I}} )$$

represents the actual CH (i) power to receive data from node (j) through Bluetooth. Similarly

$$\frac{{r}_{j}}{{R}_{i}^{W}} ( {P}_{i}^{{W}_{A}} - {P}_{i}^{{W}_{I}} )$$

is the CH i WiFi power to forward same data.

Let S=1 . . . N be the set of nodes (electronic devices). C, denotes the clustering cost for node (i) which is defined in equation 1. FreeBWᵢ is the available bandwidth. k is the maximum number of regular nodes in a cluster (Bluetooth slaves in a piconet). Dᵢⱼ indicates if node i and j are within the Bluetooth range of each other.

$${D}_{ij} = \{ \begin{matrix}1 & if nodes i , j can reach each other \\ 0 & otherwise\end{matrix}$$

Then, the binary decision variables may be defined as:

$${X}_{ij} = \{ \begin{matrix}1 & if node j is connected to CH i \\ 0 & otherwise\end{matrix} \\ {Y}_{i} = \{ \begin{matrix}1 & if node i is a cluster head node \\ 0 & otherwise\end{matrix}$$

The method described herein reduces the tracking power consumption for all nodes in the network. Therefore, the objective function is selected as the total power consumption of the whole network. The output of the optimization model described herein is an optimal construction of cluster in terms of power consumption, specifying the CH for each cluster. The method reduces the number of nodes that are not connected to any cluster. The system may be modeled as:

$$Min {\sum }_{i = 1}^{n} {\sum }_{\begin{matrix}j = 1 \\ i \neq j\end{matrix}}^{n} {X}_{ij} \text{?} ( {P}_{j}^{B} + {P}_{j}^{frwd} ) + {\sum }_{i = 1}^{n} {Y}_{i} \text{?} ( {P}_{i}^{W} + {P}_{i}^{G} + {P}_{i}^{B} ) \\ \text{?} \text{indicates text missing or illegible when filed} \qquad ( 9 a )$$

Subject to:

$$\begin{matrix}\begin{matrix} {X}_{ij} \text{?} {C}_{i} \leq {C}_{j} & ∀ ( i , j ) ∈ S , i \neq j\end{matrix} & ( 9 b ) \\ \begin{matrix}{\sum }_{i = 1}^{n} {X}_{ij} + {Y}_{j} = 1 & ∀ ( i , j ) ∈ S , i \neq j\end{matrix} & ( 9 c ) \\ \begin{matrix} {\sum }_{i = 1}^{n} {X}_{ij} \leq 1 & ∀ ( i , j ) ∈ S , i \neq j\end{matrix} & ( 9 d ) \\ \begin{matrix} {\sum }_{j = 1}^{n} {X}_{ij} \leq k & ∀ ( i , j ) ∈ S , i \neq j\end{matrix} & ( 9 e ) \\ \begin{matrix} {\sum }_{j = 1}^{n} {X}_{ij} \text{?} {r}_{j} \leq {FreeBW}_{i} & ∀ ( i , j ) ∈ S , i \neq j\end{matrix} & ( 9 f ) \\ \begin{matrix} {X}_{ij} \text{?} {D}_{ij} & ∀ ( i , j ) ∈ S , i \neq j\end{matrix} \\ \text{?} \text{indicates text missing or illegible when filed} & ( 9 g )\end{matrix}$$

The objective function (9a) aims at minimizing the total consumption power for the whole network. The first term of the equation represents the tracking power for a node in a regular node (RN) role. It takes into account the power of the node itself to send its data to the CH via Bluetooth and the power needed by its CH to forward its data. The GPS power is neglected since RN switch off their GPS. The second term of the equation defines the tracking power of the node in CH role. The second term includes GPS power, WiFi power to transmit local data rate and the power of Bluetooth. Power to forward data of other RNs in the cluster, are determined by the first term.

Equations from (9b) to (9g) represent the problem constraints. Equation (9b) guarantees that a cluster head can only admit new members with higher cost to assure that a CH can only serve nodes that had shared their resources before, hence, enhance fairness in energy saving for all nodes. While equation (9c) ensures that all nodes are either a CH or a regular node. Equation (9d) ensures that every node is connected to one CH at most. The node should not connected to more than one CH or it should be a CH itself. Equation (9e) specifies the maximum number of nodes in a cluster, since the cluster is a Bluetooth local area network (piconet). In one implementation the Bluetooth local area network is limited to one master and seven slaves. Equation (9f) is the bandwidth requirement. CH must satisfy the bandwidth requirements of all nodes in its cluster and it can't accept new RN if it doesn't have sufficient bandwidth to serve it. Finally, constraint (9g) assures that every cluster head is reachable by all nodes in its cluster.

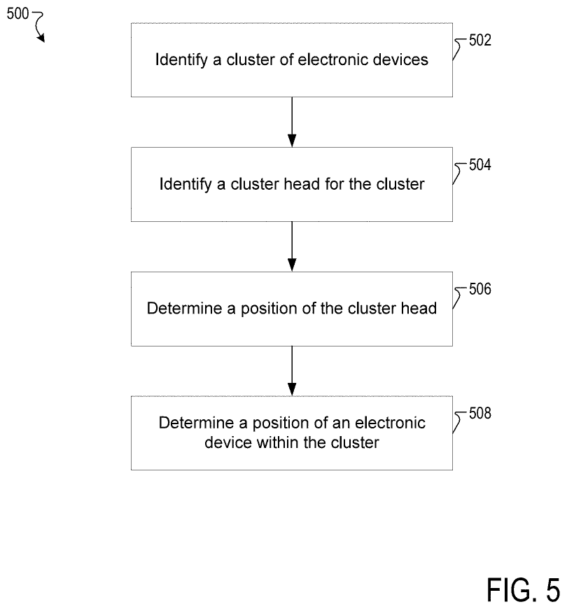

FIG. 5 is a flowchart 500 for a method for tracking an object according to one example. The object may include a person associated with the electronic device.

At step 502, the server 102 may identify a cluster of electronic devices.

At step 504, the server 102 identifies the cluster head of the cluster. For example, the server 102 determines that an electronic device is a cluster head in response to receiving data or information from the electronic device via the base station. The cluster head is determined as described previously herein. The battery level of each electronic device may be advertised as the cost. In addition, the cost may further include an expected recharge time (i.e., the time when the battery is to be recharged). For example, a user may indicate the expected recharge time using an interface of the application downloaded to the electronic device.

In one implementation, the electronic device may determine the expected recharge time based on a past data (i.e., collected history). For example, the processing circuitry may track and store the time and day when the user recharges the electronic device (e.g., determine that the user recharge the battery at 2 PM every day). The cost may include the expected recharge time. For example, if two electronic devices have the same battery level, the electronic device with the nearest expected recharge time may be selected as the cluster head. In other embodiments, the expected recharge time may be a factor in the broadcasted cost. For example, each electronic device may calculate the cost including a current battery level and the expected time of recharge. For example, the expected recharge time may be worth 10% of the cost. In one implementation, the expected recharge time may be mapped to a predetermined numerical value (e.g., stored in a database or a memory of the electronic device). For example, if the expected recharge time is in less than one hour. The numerical value may be −1. If the expected recharge time is between one hour and two hours, the numerical value may be zero. If the expected recharge time is more than two hours, the numerical value may be equal to one.

At step 506, the server 102 determines a position of the cluster head. The server 102 may determine the position of the cluster head using the long range transmitter of the cluster head.

At step 508, the server 102 determines a position of each electronic device within the cluster other than the cluster head using data from the short-range transmitter of the electronic device received by the cluster head and the position of the cluster head. For example, the cluster head may receive the data from each electronic device via the short range transmitter then the cluster head transmits the data to the server 102.

In one implementation, the server 102 may track the electronic device. For example, the server 102 may store the position of the electronic device and associated time and date in the database (e.g., cloud database).

Actual power consumption in the system may be tracked. The weight of the cluster cost may be adjusted based on the actual power consumption and the consumption for an optimal model as described previously herein.

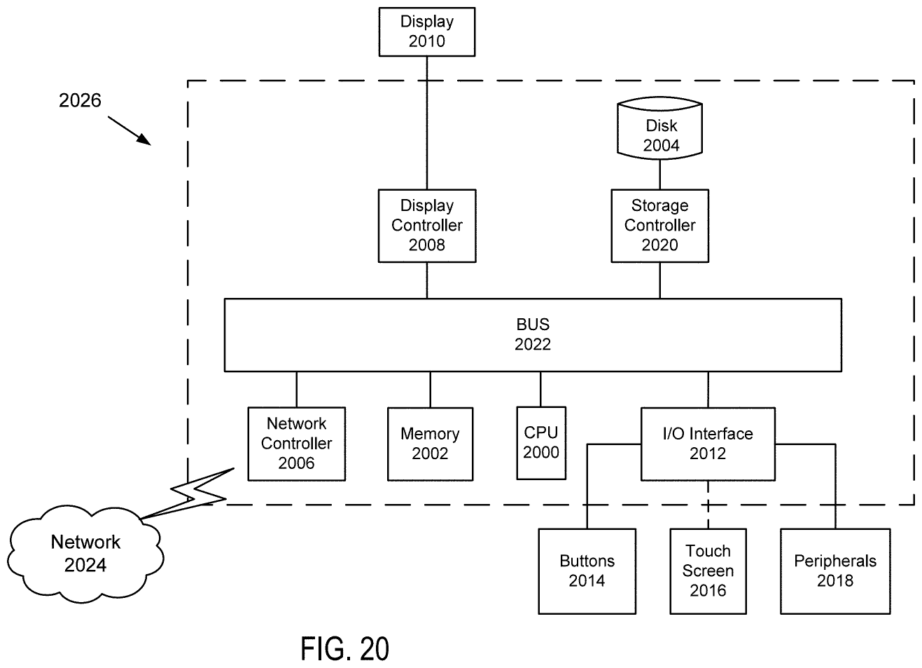

The electronic device 108 may contain hardware similar to that illustrated in FIG. 20, and the databases of the system may correspond to a memory of the electronic device 108. Further, in some embodiments, the system may be implemented as an application that may be downloaded on the electronic device 108.

Although the flow charts show specific orders of executing functional logic blocks, the order of executing the block blocks may be changed relative to the order shown, as will be understood by one of ordinary skill in the art. Also, two or more blocks shown in succession may be executed concurrently or with partial concurrence.

To illustrate the capabilities of the method described herein, exemplary results are presented.

The system and method described herein are evaluated using simulation and through physical implementations of a CEET smartphone application. First, the evaluation through simulation is described and compared to the optimal solution obtained from the optimization model. Then, the performance evaluation of the CEET smartphone application is described.

### EXAMPLES

In one example, the method for tracking described herein is evaluated through simulation experiments using the computational tool MATLAB. All nodes are equipped with WiFi, Bluetooth and GPS modules. All nodes have access to a WiFi access point. All nodes are deployed in an outdoor field and all of them have an access to GPS signals. Power consumption values, used in the simulation, are specified in table 1. These values are real-world values obtained from the power profiles in Android developer guide.

The mobility of the nodes follows the random waypoint model. In one example, all nodes are uniformly spread into 50*50 meters field. Each node starts at a random location and chooses its next destination randomly. The node moves to its destination with a speed selected randomly between 0.5 and 2 m/s with a pause interval between 30 and 60 seconds. The traffic model used in the simulation is constant bit rate (CBR) traffic model. Each node generates random data rate between 0 and 1 mbps. This data rate lasts for a random period between 0 and 120 seconds then it generates another random data rate and it lasts for another random period and so on. The simulation lasts for 30 minutes unless it is explicitly specified.

TABLE 1
SIMULATION PARAMETERS AND VALUES

| Parameter | Abbreviation | Values | |
|---|---|---|---|
| Battery level | — | [100:2000] | mAh |
| Data model | — | CBR | |
| Data rate (uniform distribution) | r | [0:1] | mbps |
| Bluetooth on power | p^{B}_{I} | 0.37 | mW |
| Bluetooth Active (Tx/Rx) power | p^{B}_{A} | 37 | mW |
| WiFi on power | p^{W}_{I} | 11.1 | mW |
| WiFi Active power | p^{B}_{I} | 740 | mW |
| GPS power | p^{G} | 185 | mW |
| WiFi TX Rate | R^{W} | 150 | Mbps |
| Bluetooth TX Rate | R^{B} | 2 | Mb |

Evaluation of Cluster Construction

The optimal solution is based on finding the optimal construction of clusters in terms of energy consumption. The method may model the system as a mixed Integer Programming problem. The model may be implemented using a GAMS solver. GAMS is a high-level modeling system for mathematical optimization which is designed for modeling and solving different range of optimization problems. It is worth to note that GAMS has limitations which makes it inconvenient to use GAMS for large networks (nodes >800 nodes). Different network densities 100, 200, 400 and 800 are used. Values of objective function provided by GAMS and the average consumed energy values resulting from the method described herein are compared.

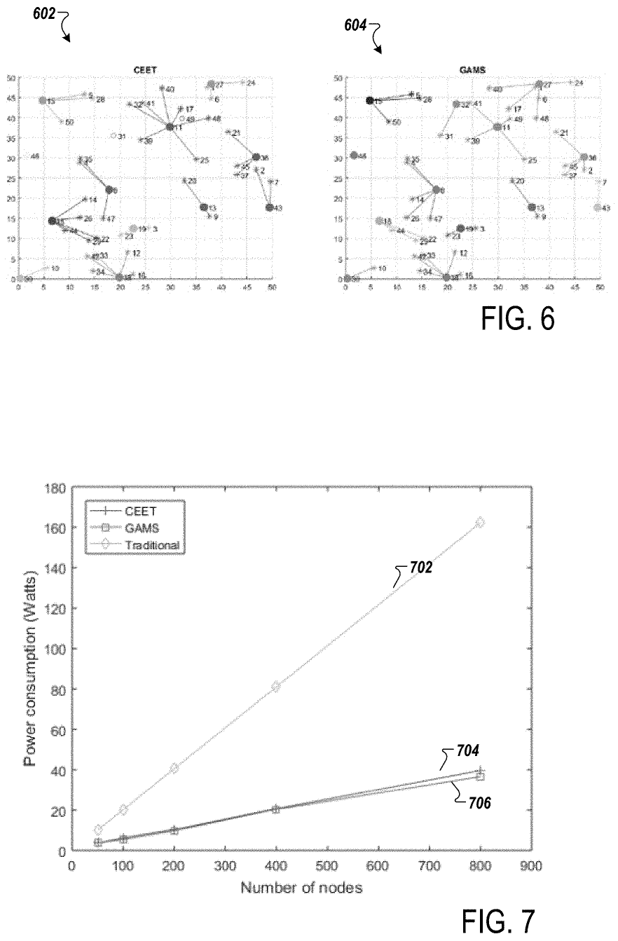

FIG. 6 is a schematic that shows the difference in the initial clustering construction between CEET 602 and the optimization model 604 solved by GAMS. The optimization model has a global knowledge of the network, unlike the method described herein where nodes have local information about surrounding neighbors. Thus, the cluster construction provided by GAMS is more efficient and yields better constellations than the construction done by the simulation. Nevertheless, the power consumption results using the method described herein are closed to the results of the optimization model solved by GAMS. As illustrated in FIG. 7, power values from CEET simulation and the optimal power values provided by GAMS are very close for different network densities. Trace 702 shows the power consumption of the system using a traditional approach. Trace 704 shows the power consumption of a system using the method described herein. Trace 706 shows the power consumption of a system using the optimization model solved by GAMS.

Trace 704 and Trace 706 show a huge power reduction (about 70% drop when there are 100 nodes in the field and about 75% drop when more than 200 exist) in both CEET and the optimization model comparing to the traditional approach (Trace 702).

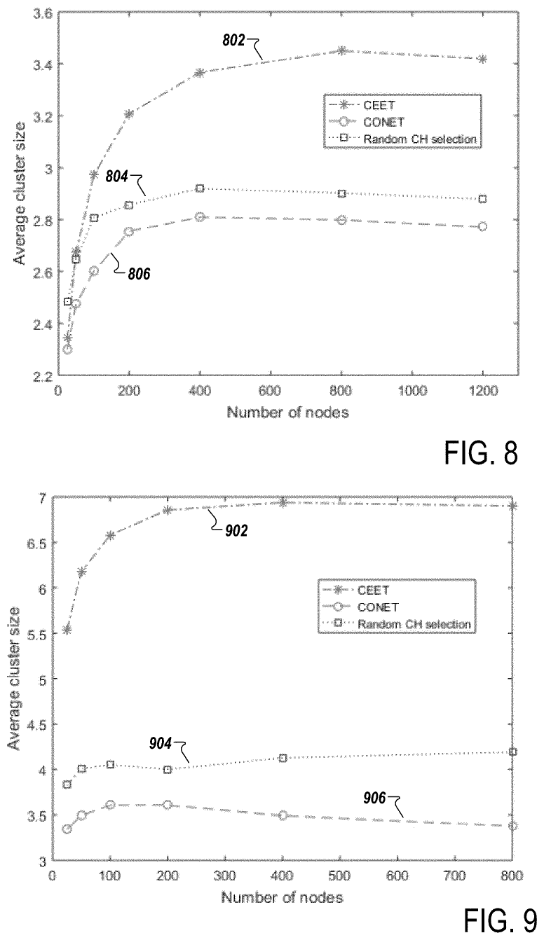

FIG. 8 is a schematic that shows the cluster size of CEET comparing to CONET and the random Ch selection in different node density according to one example. Trace 802 shows the average cluster size for a system using the method described herein. Trace 804 shows the average cluster size for a system using random CH selection. Trace 806 shows the average cluster size for a system using CONET. CONET has the smallest cluster size because it has a restricted admittance procedure. CH in CONET approach accepts new nodes only if they have higher cost even if it is already chosen as a CH. In the method described herein, a non-trivial CH accepts new nodes no matter what their cost is, as long as it has enough bandwidth and the number of nodes in a cluster does not exceed the upper bound of the allowed maximum cluster size.

Cluster sizes shown in FIG. 8 are with random data rate between 0 and 1 mbps. Nodes are rejected to join clusters if the cluster head cannot satisfy their bandwidth requirements. Moreover, nodes disconnect from clusters if their data rate cannot be served at any moment. As discussed previously herein, the data rate is so low and can be neglected so the bandwidth don't play a role in admitting or disconnecting from a cluster.

FIG. 9 is a schematic 900 that shows the cluster size with very low data rate (20 bytes every 30 seconds). Cluster size is doubled in CEET when there is dense nodes in the field. Whereas CONET does not get significant improvement due to the cost constraint. Trace 902 shows the average cluster size for a system using the method described herein. Trace 904 shows the average cluster size for a system using random CH selection. Trace 906 shows the average cluster size for a system using CONET.

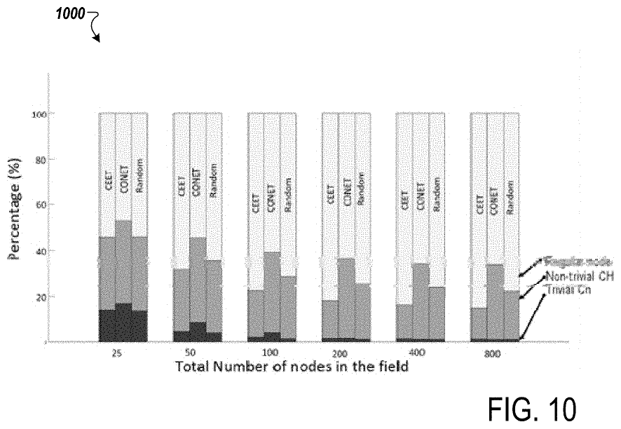

FIG. 10 shows the effect of node density and the choice of clustering algorithm on the cluster organization. As described earlier, CONET has stricter admission policy than the other two algorithms CEET and random. In the all different densities implemented, CONET has the less average time as a regular node. For example, when there are 25 nodes in the field nodes spend less than 45% of its time as a regular node while it spends more than 55% in both CEET and Random. As the number of the nodes increases, the percentage of the average time of nodes spend as a trivial CH (not cooperating) decreases since it has more neighboring nodes to cooperate. When there are 800 nodes in the field nodes spend more than 30% in the CH role in the CONET approach due to the small cluster size illustrated in FIG. 9 while nodes spend in average as CH around 15% in CEET and around 23% in Random.

Evaluation of Power Consumption

The performance results of CEET compared to CONET, the traditional approach and the random CH selection approach (Random) are discussed next. In the traditional approach each node is working individually using its own WiFi and GPS for tracking. CEET, CONET and Random are using clustering for sharing the tracking task. However, both CEET and CONET define a cost function that is used as a base for selecting the CH. On the other hand, Random used probability values randomly generated and assigned to nodes to be used for selecting CH without considering any other metric.

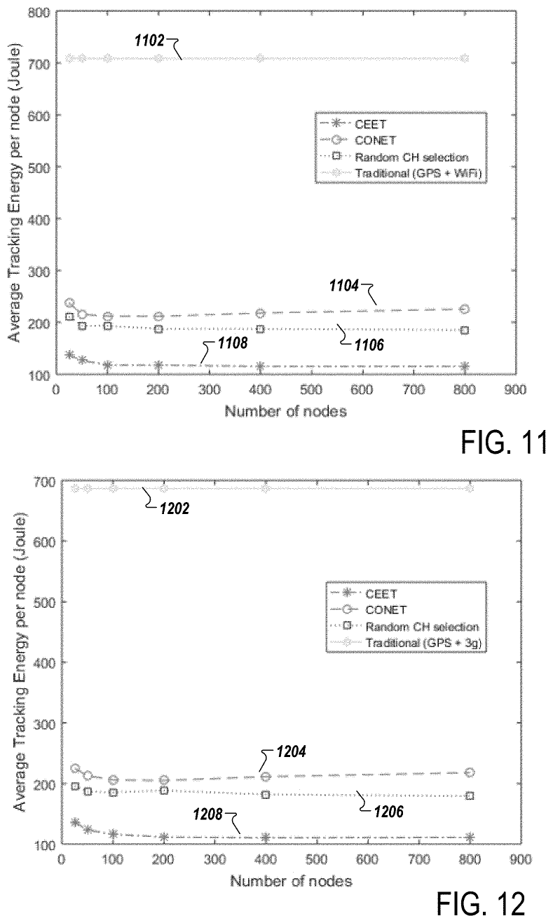

FIG. 11 is a schematic that shows the effect of node density on the energy consumption per node according to one example. Trace 1102 shows the average racking energy per node for the system using a traditional approach. Trace 1104 shows the average racking energy per node for the system using CONET. Trace 1106 shows the average racking energy per node for the system using random CH selection. Trace 1108 shows the average racking energy per node for the system using the method described herein. On average, each node consumes around 700 Joules for tracking when it uses the traditional approach for the experiment period of one hour. On the other hand, the node tracking energy consumption decreases when applying a clustering algorithm. For example, when applying CEET the average power consumption per node when there are 100 nodes in the field, is 118 Joule which is 17 percent of the power used in the traditional way. The energy saving increases when more nodes exist in the field because nodes can spend more time as regular node, hence, it consumes less power for positioning and communication. FIG. 11 shows that the average power consumption decreases as the number of nodes decreases till some point where the power consumption stabilizes and no matter how many nodes added to the field. In this example, there is no substantial difference in the power consumption as the number of nodes increase above 100 nodes in the field.

FIG. 12 is a schematic that shows the energy consumption when using the cellular mobile data instead of WiFi in all above mentioned approaches (traditional, CEET, CONET and random). Trace 1202 shows the average racking energy per node for the system using a traditional approach. Trace 1204 shows the average racking energy per node for the system using CONET. Trace 1206 shows the average racking energy per node for the system using random CH selection. Trace 1208 shows the average racking energy per node for the system using the method described herein.

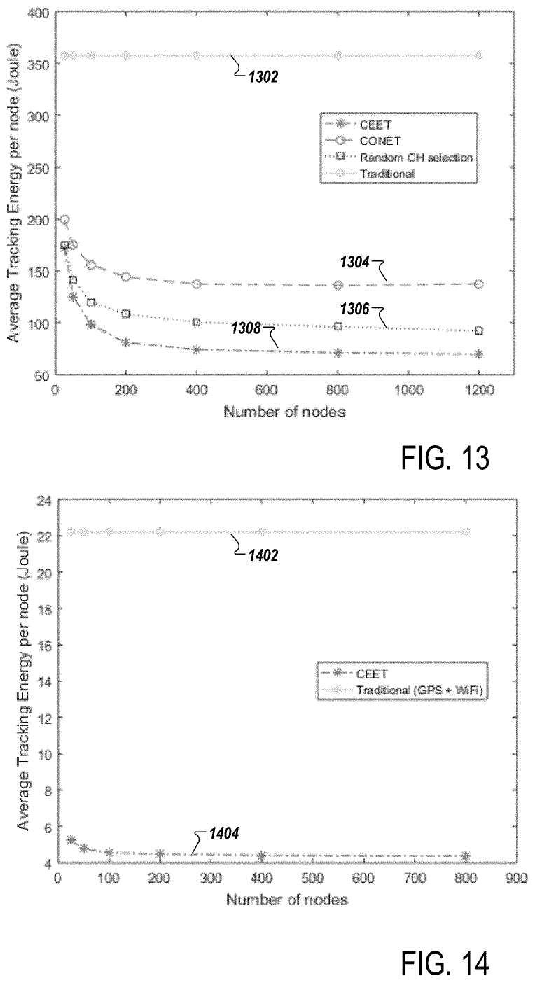

FIG. 13 is a schematic that shows the average power consumption per node with low data rate 20 bytes every 30 seconds (to simulate the data rate in the system described herein). Trace 1302 shows the average racking energy per node for the system using a traditional approach. Trace 1304 shows the average racking energy per node for the system using the method described herein. The energy saving is higher with low data rate because more regular nodes can be admitted and longer time they can stay as regular nodes.

FIG. 14 is a schematic that shows the average power consumption per node with low data rate 20 bytes every 30 seconds (to simulate the data rate in the system described herein). In this setup, the traditional approach is modified. The WiFi and GPS stay off and only switch on periodically every 30 seconds to obtain the location data and send the tracking data to the server through the WiFi interface. Once the data is sent, both GPS and WiFi are switched off again for 30 seconds till the next scheduled reporting. The CEET is configured such that the CH only switch on its GPS and WiFi once every 30 seconds. Other regular nodes don't need to switch on their WiFi and GPS since they forward their data to the CH through the Bluetooth.

Trace 1402 shows the average racking energy per node for the system using a traditional approach. Trace 1401 shows the average racking energy per node for the system using the method described herein. Although CEET requires additional power for the Bluetooth, but it still outperforms the traditional approach because all regular nodes save the GPS power since GPS is off all the time they are in the regular node rule.

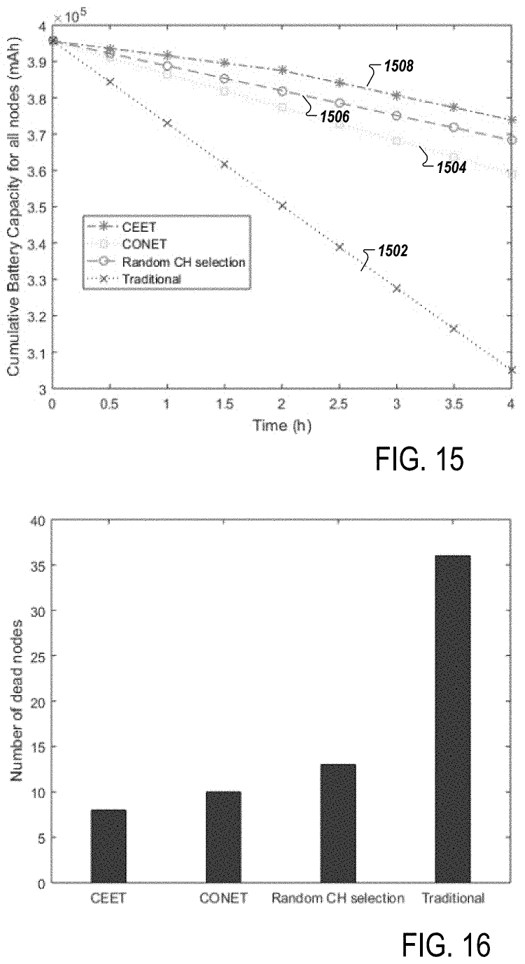

FIG. 15 is a schematic that shows the cumulative battery capacity for all nodes in the network over time. In this example, the system includes 400 nodes in the field and the battery level of each node is chosen randomly between 100 and 2000 mAh. The same values have been used to test the different schemes in three different experiments run for 4 hours each. Trace 1502 shows the average racking energy per node for the system using a traditional approach. Trace 1504 shows the average racking energy per node for the system using CONET. Trace 1506 shows the average racking energy per node for the system using random CH selection. Trace 1508 shows the average racking energy per node for the system using the method described herein.

FIG. 16 is a schematic that shows a number of dead nodes for different system according to one example. The effectiveness of CEET is increased by minimizing the number of dead nodes due to their drained batteries of participating nodes.

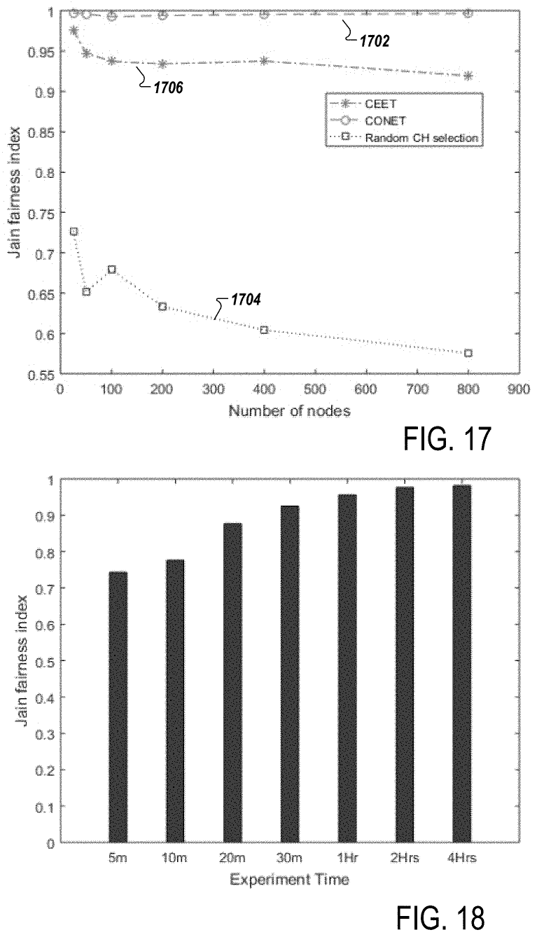

Fairness and load balancing Fairness is very important performance measure that should be addressed in a cooperative approach. The fairness of battery saving depends on the clustering scheme used and the role switching time. FIG. 17 shows the Jain fairness index for CEET compared to CONET and the random approach for different network densities. See Jain, R. K., Chiu, D. M. W., Hawe, W. R. (1984), A Quantitative Measure of Fairness and Discrimination, Eastern Research Laboratory, Digital Equipment Corporation, Hudson, Mass., incorporated herein by reference in its entirety. The Jain fairness index is based on the battery saving ratio (SR) for each node which is computed based on the ratio of saved energy to the energy used by the traditional approach. SR for node i can be defined as follows.

$${SR}_{i} = \frac{{E}_{i}^{Tr} - {E}_{i}^{CEET}}{{E}_{i}^{Tr}} \qquad ( 10 )$$

The Jain fairness index is defined as follow:

$$JainFairnessIndex = \frac{{\sum }_{i = 1}^{n} {( {SR}_{i} )}^{2}}{n \text{?} ( {\sum }_{i = 1}^{n} {( {SR}_{i} )}^{2} )} \\ \text{?} \text{indicates text missing or illegible when filed} \qquad ( 11 )$$

A larger value of Jain's index represents a fairer energy saving for all nodes.

FIG. 17 shows the Jain's fairness index for energy saving. CONET scores the best in fairness. CEET come next with very close fairness results to CONET. This slightly difference in fairness between CONET and CEET can be tolerated because of the higher gain CEET achieves in terms of improving energy efficiency.

Trace 1702 shows the average racking energy per node for the system using CONET. Trace 1704 shows the average racking energy per node for the system using random CH selection. Trace 1706 shows the average racking energy per node for the system using the method described herein.

Both CEET and CONET outperform the random CH selection approach in term of fairness for a fixed experiment time of 30 minutes as shown in FIG. 17. However, FIG. 18 shows that as the time of the experiment increases the fairness index for the random approach improves and approaches the fairness index of CEET and CONET. This means the random approach is preferable over CONET for situations when the cooperative approach run for long time with enough users nearby along all the time of cooperation because it guarantees high values of fairness besides the energy savings is better than CONET.

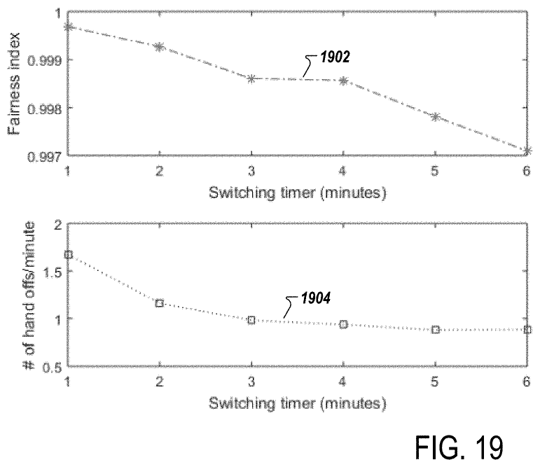

FIG. 19 illustrates the effect of switching timer on fairness of saving energy. It shows the Jain fairness index for Energy saving ratio with different switching timers. As expected, trace 1902 shows that the smaller switching period, the fairer energy saving for all nodes. However, trace 1904 also shows that the number of hand offs increases as the switching time decreases. Choosing short period for switching will increase fairness among nodes but it may affect the stability of the network due to frequent hand offs. However, choosing the suitable switching time should be determined carefully to assure stability and acceptable level of fairness.

In one implementation, the functions and processes of the server 102 may be implemented by a computer 2026. Next, a hardware description of the computer 2026 according to exemplary embodiments is described with reference to FIG. 20. In FIG. 20, the computer 2026 includes a CPU 2000 which performs the processes described herein. The process data and instructions may be stored in memory 2002. These processes and instructions may also be stored on a storage medium disk 2004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 2026 communicates, such as a server or computer.

Further, the claimed advancements may be provided as a utility application, background daemon, or component of an operating system, or combination thereof, executing in conjunction with CPU 900 and an operating system such as Microsoft® Windows®, UNIX®, Oracle® Solaris, LINUX®, Apple macOS® and other systems known to those skilled in the art.

In order to achieve the computer 2026, the hardware elements may be realized by various circuitry elements, known to those skilled in the art. For example, CPU 2000 may be a Xenon® or Core® processor from Intel Corporation of America or an Opteron® processor from AMD of America, or may be other processor types that would be recognized by one of ordinary skill in the art. Alternatively, the CPU 2000 may be implemented on an FPGA, ASIC, PLD or using discrete logic circuits, as one of ordinary skill in the art would recognize. Further, C P U 2000 may be implemented as multiple processors cooperatively working in parallel to perform the instructions of the inventive processes described above.

The computer 2026 in FIG. 20 also includes a network controller 2006, such as an Intel Ethernet PRO network interface card from Intel Corporation of America, for interfacing with network 2024. As can be appreciated, the network 2024 can be a public network, such as the Internet, or a private network such as LAN or WAN network, or any combination thereof and can also include PSTN or ISDN sub-networks. The network 2024 can also be wired, such as an Ethernet network, or can be wireless such as a cellular network including EDGE, 3G and 4G wireless cellular systems. The wireless network can also be WiFi®, Bluetooth®, or any other wireless form of communication that is known.

The computer 2026 further includes a display controller 2008, such as a NVIDIA® GeForce® GTX or Quadro® graphics adaptor from NVIDIA Corporation of America for interfacing with display 2010, such as a Hewlett Packard® HPL2445w LCD monitor. A general purpose I/O interface 2012 interfaces with a keyboard and/or mouse 2014 as well as an optional touch screen panel 2016 on or separate from display 2010. General purpose I/O interface also connects to a variety of peripherals 2018 including printers and scanners, such as an OfficeJet® or DeskJet® from Hewlett Packard®.

The general purpose storage controller 2020 connects the storage medium disk 2004 with communication bus 2022, which may be an ISA, EISA, VESA, PCI, or similar, for interconnecting all of the components of the computer 2026. A description of the general features and functionality of the display 2010, keyboard and/or mouse 2014, as well as the display controller 2008, storage controller 2020, network controller 2006, and general purpose I/O interface 2012 is omitted herein for brevity as these features are known.

Numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A system for tracking and reporting an object using electronic devices, the system comprising:
a plurality of electronic devices, each electronic device including
a short-range transmitter,
a long-range transmitter, and
processing circuitry configured to
broadcast data via the short-range transmitter, the data including a clustering cost,
identify as a regular node or a cluster head for a cluster based on at least the clustering cost associated with each of the electronic devices,
transmit location data to the cluster head using the short-range transmitter when the electronic device is identified as the regular node, and
transmit gathered location data to a server using the long-range transmitter when the electronic device is the cluster head, the gathered location data including the location data received from other electronic devices in the cluster; and
a server including processing configured to
identify the cluster of electronic devices,
identify the cluster head for the cluster,
determine a position of the cluster head using data received via the long-range transmitter of the cluster head,
determine a position of each electronic device within the cluster using the gathered location data and the position of the cluster head,
store the position of each electronic device in a database of the server and
report the position and tracked information to an external device.

2. The system of claim 1, wherein the data further includes a network address, a bandwidth, and location information.

3. The system of claim 2, wherein the clustering cost further includes an expected time of recharge of the battery.

4. The system of claim 2, wherein the processing circuitry of the electronic device is further configured to:
send a request to a cluster head when the cluster head has a lowest clustering cost among other electronic devices.

5. The system of claim 1, wherein a cluster head disconnect from the cluster when a predetermined period of time expires.

6. The system of claim 5, wherein each of the electronic device disconnect from the cluster when the cluster head disconnects, and each of the electronic devices connects to another cluster or select a new cluster head.

7. The system of claim 2, wherein the electronic device include another long-range transmitter.

8. The system of claim 1, wherein the processing circuitry of the electronic device is further configured to
identify a bandwidth of the cluster head, and
disconnect from the cluster when the bandwidth is below a threshold associated with the electronic device.

9. The system of claim 1, wherein the clustering cost corresponds to an energy consumption of the electronic device starting at a time corresponding to the electronic device joining the cluster.

10. The system of claim 9, wherein the energy consumption includes the power used by the short range transmitter and the long range transmitter.

11. The system of claim 1, wherein the processing circuitry of the electronic device is further configured to:
deactivate the long-range transmitter when the electronic device is a regular node; and
reactivate the long-range transmitter for a predefined period of time when the electronic device is a cluster head.

12. The system of claim 11, wherein the predefined period of time optimizes an operation of the system.

13. An electronic device, comprising:
a short-range transmitter,
a long-range transmitter, and
processing circuitry configured to
broadcast data via the short-range transmitter, the data including a clustering cost,
determine whether a join request is received from another electronic device to form a cluster,
accept the join request when a bandwidth associated with the electronic device is greater than a predetermined threshold,
receive location data from the another electronic device,
transmit the location data to a server using the long-range transmitter.

14. A method for tracking an object using electronic devices, the method comprising:
broadcasting data via a short-range transmitter of an electronic device, the data including a clustering cost;
determining whether a join request is received from another electronic device to form a cluster;
accepting the join request when a bandwidth associated with the electronic device is greater than a predetermined threshold;
receiving location data from the another electronic device; and
transmitting the location data to a server using a long-range transmitter of the electronic device.

15. The method of claim 14, further comprising:
sending a join request to one or more electronic devices when a clustering cost associated with the one or more electronic devices is lower than the clustering cost associated with the electronic device; and
changing a role of the electronic device from a cluster head to a regular node in response to determining that an accept acknowledgment is received from the one or more electronic devices.

16. The method of claim 15, further comprising:
deactivating the long-range transmitter when the electronic device role is a regular node; and
reactivating the long-range transmitter for a predefined period of time when the electronic device role is a cluster head.

17. The method of claim 15, wherein the clustering cost includes a battery level and an expected time of recharge of a battery of the electronic device.

18. The method of claim 17, wherein the expected time of recharge of the battery is determined using past data.

19. The method of claim 18, wherein the clustering cost is reduced when the expected time of recharge is in less than a predetermined threshold.

20. The method of claim 15, wherein a cluster head disconnect from the cluster when a predetermined period of time expires.
